(19) United States
(12) Patent Application Publication
(10) Pub. No.: US 2023/0068933 A1
(43) Pub. Date: Mar. 2, 2023

(54) SYSTEMS AND METHODS FOR DETERMINING CHANGED CIRCUMSTANCES AND GENERATING RECOMMENDATIONS FOR APPROPRIATE PROGRAMS

(71) Applicant: Capital One Services, LLC, McLean, VA (US)

(72) Inventors: Qiaochu TANG, The Colony, TX (US); Staevan DUCKWORTH, Oak Point, TX (US); Avid GHAMSARI, Austin, TX (US); Jason Richard HOOVER, Grapevine, TX (US); Micah PRICE, Boulder, CO (US); Geoffrey DAGLEY, McKinney, TX (US)

(73) Assignee: Capital One Services, LLC, McLean, VA (US)

(21) Appl. No.: 17/463,794

(22) Filed: Sep. 1, 2021

(51) Int. Cl. G06Q 20/38; G06F 11/34; G06N 5/04; G06Q 20/36

(52) U.S. Cl. CPC G06Q 20/389; G06F 11/3438; G06N 5/04; G06Q 20/363; G06Q 40/00

(57) ABSTRACT

Systems and methods of determining changes in an individual's interaction patterns indicative of changed circumstances are disclosed. An exemplary method can include receiving a first set of interaction records relating to an individual and creating an interaction profile based on the first set of interaction records. The method can also include monitoring a second set of more recent interaction records, comparing the second set of interaction records to the interaction profile to identify one or more changes to the interaction patterns identified in the first set of interaction records, analyzing the one or more changes to the interaction patterns to determine if the one or more changes is indicative of a changed circumstance for the individual, and generating recommendations for programs to be presented to the individual based on the changes to the interaction patterns identified in the first set of interaction records.

### TECHNICAL FIELD

Various embodiments of the present disclosure relate generally to methods and systems for detecting changed circumstances based on interaction records and, more particularly, to methods and systems for determining changed circumstances and generating recommendations for programs that may be appropriate for the changed circumstance.

### BACKGROUND

Changed circumstances, such as a reduction or increase of income, an unexpected expense, or financial windfall, are a normal part of life. When they occur, they can alter an individual's ability to meet financial obligations or they can present additional financial opportunities. When circumstances change for a person in such a way as to impact their financial situation, institutions with which the individual may have relationships or accounts are often unaware. While knowledge of changes in circumstance may be beneficial to both the person and the institutions with which they may have accounts, it may be difficult for the person to provide that information directly, for reasons that can include a lack of available time, discomfort discussing adverse changes, or privacy concerns. This lack of knowledge on the part of an institution may needlessly prevent or delay offers of available assistance, such as programs designed for those dealing with hardships or new opportunities to save.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure methods, systems, and non-transitory computer-readable media are disclosed for recognizing changed circumstances and recommending appropriate programs. Each of the examples disclosed herein may include one or more of the features described in connection with any of the other disclosed examples.

In one aspect, an exemplary embodiment of a method for recognizing changes in an individual's interaction patterns indicative of changed circumstances may include: receiving a first set of interaction records relating to an individual and creating an interaction profile based on the first set of interaction records, wherein the interaction profile includes information regarding interaction patterns identified in the first set of interaction records. An exemplary method may further include receiving a second set of interaction records related to interactions that are more recent than those reflected in the first set of interaction records, and comparing the second set of interaction records to the interaction profile to identify one or more changes to the interaction patterns identified in the first set of interaction records. An exemplary method may continue by analyzing the one or more changes to the interaction patterns to determine if the one or more changes is indicative of a changed circumstance for the individual, and generating one or more recommendations for programs to be presented to the individual based on the one or more changes to the interaction patterns identified in the first set of interaction records.

An exemplary embodiment of a system for recognizing changes in an individual's interaction patterns indicative of changed circumstances may include a memory storing instructions and a processor executing the instructions to perform a process. The process may include receiving a first set of interaction records relating to an individual, and creating an interaction profile based on the first set of interaction records, wherein the interaction profile includes information regarding interaction patterns identified in the first set of interaction records. The process may further include receiving a second set of interaction records related to interactions that are more recent than those reflected in the first set of interaction records, comparing the second set of interaction records to the interaction profile to identify one or more changes to the interaction patterns identified in the first set of interaction records, analyzing the one or more changes to the interaction patterns to determine if the one or more changes is indicative of a changed circumstance for the individual, and generating one or more recommendations for programs to be presented to the individual based on the one or more changes to the interaction patterns identified in the first set of interaction records.

A non-transitory computer-readable medium may store instructions that, when executed by a processor, cause the processor to perform a method including receiving a first set of interaction records relating to two or more accounts owned by an individual and creating an interaction profile based on the first set of interaction records, wherein the interaction profile includes information regarding interaction frequency, interaction volume, and categories of interactions. The method may include receiving a second set of interaction records related to interactions that are more recent than those reflected in the first set of interaction records, and comparing the second set of interaction records to the interaction profile to identify one or more changes to the interaction frequency, interaction volume, or categories of interactions identified in the first set of interaction records. The method may further include analyzing the one or more changes to the interaction frequency, interaction volume, or categories of interactions to determine if the one or more changes is indicative of a changed circumstance for the individual, generating one or more recommendations for programs to be presented to the individual based on the one or more changes to the interaction patterns identified in the first set of interaction records, presenting the one or more recommendations for programs to the individual, and enrolling the individual in a program included in the one or more recommendations for programs in response to feedback from the individual.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment that may be utilized according to aspects of the present disclosure.

FIG. 2 depicts an exemplary process for identifying changed circumstances and providing recommendations for relevant programs.

FIG. 3 depicts an exemplary process for determining if changes to interaction patterns are indicative of changed circumstances.

FIG. 4 depicts an exemplary process for providing recommendations to an individual and enrolling them in selected programs.

FIG. 5 depicts an example of a computing device, according to aspects of the present disclosure.

### DETAILED DESCRIPTION OF EMBODIMENTS

The terminology used in this disclosure is to be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “computer system” generally encompasses any device or combination of devices, each device having at least one processor that executes instructions from a memory medium. Additionally, a computer system may be included as a part of another computer system.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” “about,” and “generally,” are used to indicate a possible variation of ±10% of a stated or understood value.

In general, the present disclosure provides methods and systems for recognizing changed circumstances and recommending programs that may be appropriate for the changed circumstance. Institutions may have programs or other tools at their disposal that could benefit an individual going through changing circumstances if they are aware of those changes. For example, in the event of a loss or reduction of income, an institution may be able to foresee potential future financial difficulties and preemptively offer assistance such as refinancing an obligation or deferring a payment that would otherwise be due. However, as many such changes in circumstance are not expressly communicated to the financial institutions with which the person may have accounts, institutions that want to provide better assistance to their customers may benefit from alternate methods of learning about a person's changed circumstances. Institutions being put in a better position to know about potential changed circumstances prior to issues arising can benefit the customer, by allowing assistance to be proactively offered.

The methods and systems disclosed may enable an institution to identify a change in circumstance based on transaction records and other information available to the institution. It is often the case that a person's financial transaction patterns change as a result of a changed circumstance, even prior to a missed payment. For example, a person may immediately begin dining out less frequently following a job loss, or increase their spending on medical care following the identification of a health issue. A customer under duress may be unlikely to contact their financial institutions prior to a bill being past due, and as a result, an institution that is able to detect a change in transaction patterns prior to a payment being missed, may be able to provide assistance sooner and with fewer consequences to the customer.

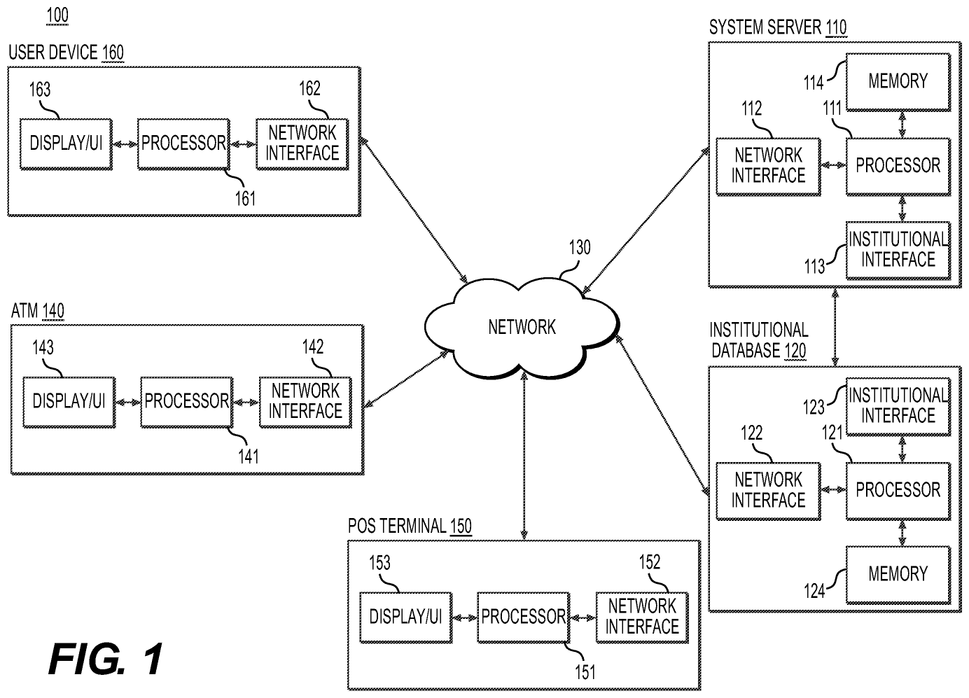

FIG. 1 depicts an exemplary system environment 100 that may be utilized with techniques presented herein. For example, the environment 100 may include system server 110 which may obtain and analyze interaction records. System server 110 may include a processor 111 to execute instructions, and a network interface 112 with which to communicate with other elements in system environment 100. System server 110 may also include an institutional interface 113, in addition to or in combination with network interface 112, which may enable system server 110 to communicate with a secure institutional database 120. Instructions to be executed by processor 111 may be stored in memory 114.

Institutional database 120 may be, for example, a secure server or other system associated with an institution and on which interaction data may be stored. Institutional database 120 may include a processor 121 that may execute instructions stored in a memory 124 in order to allow institutional database 120 to receive and store interaction data received via a network interface 122 and/or an institutional interface 123.

Network interface 112 of system server 110 and network interface 122 of institutional database 120 may communicate with each other and/or other elements of the system environment 100 via network 130. Network 130 may be implemented as, for example, the Internet, a wireless network, a wired network (e.g., Ethernet), a local area network (LAN), a Wide Area Network (WANs), Bluetooth, Near Field Communication (NFC), or any other type of network or combination of networks that provides communications between one or more components of the system environment 100. In some embodiments, the network 130 may be implemented using a suitable communication protocol or combination of protocols such as a wired or wireless Internet connection in combination with a cellular data network.

Network 130 may provide system server 110 and institutional database 120 with access to data associated with user interactions such as those conducted via an automated teller machine (ATM) 140, a point of sale (POS) terminal 150, and/or a user device 160. ATM 140 may include a processor 141, a network interface 142, and a display/user interface (UI) 143. Processor 141 may enable ATM 140 to conduct interactions with users, and provide data regarding those interactions, via network 130 and network interface 142, to system server 110 and institutional database 120. Similarly, POS terminal 150 may include a processor 151, a network interface 152, and a display/UI 153. POS terminal 150 may carry out interactions such as commercial transactions by using processor 151, and can in turn provide data regarding those interactions, via network 130 and network interface 152, to system server 110 and institutional database 120.

User device 160 can be, for example, a computer, smartphone, tablet, or other network-accessible computing device, and may include a processor 161, a network interface 162, and a display/UI 163. User device 160 may be capable of allowing a user to conduct interactions, and it may further allow the user to receive information from institutions. Processor 161 may execute instructions to perform functions including, for example, transacting with POS terminal 150, providing data regarding those or other interactions to system server 110 and/or institutional database 120, and/or presenting a user with information received from system server 110.

While system environment 100, as illustrated in FIG. 1, is depicted as having a single ATM 140, POS terminal 150, and user device 160, this disclosure contemplates that there may be more than one of one or more of these (or other) elements without departing from the scope of the disclosure. For example, the user may conduct interactions with multiple ATMs, multiple POS terminals, and/or multiple different user devices.

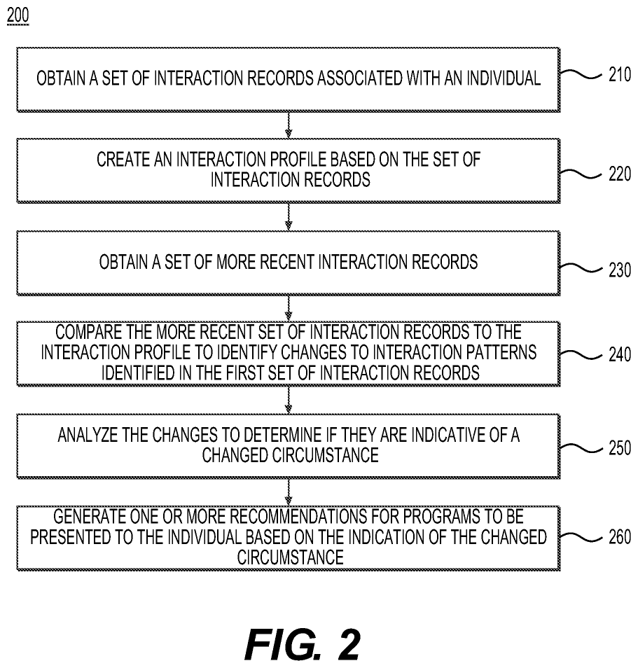

FIG. 2 illustrates a method 200 for recognizing changed circumstances and recommending appropriate programs, according to some embodiments of the present disclosure. The method may be performed by a system in accordance with the present disclosure, including one or more of the devices that comprise the system environment 100. For example, in some embodiments in accordance with the present disclosure, method 200 may be carried out by system server 110.

Method 200 may begin at step 210 with the receipt of a set of interaction records associated with an individual. The set of interaction records may be obtained, via network 130 (and/or institutional interfaces 113, 123), from one or more of institutional database 120, ATM 140, POS terminal 150, and user device 160. The set of interaction records may include information such as, for example, the identity of parties involved, an amount being transacted, and nature of interaction.

Once obtained, method 200 may continue at step 220 with the creation of an interaction profile based on the set of interaction records. The interaction profile may include the set of interaction records, interaction patterns identified in the set of interaction records, demographic or background information related to the individual, or other information relevant to the individual and/or interactions. For example, an interaction profile may include trends and patterns such as the category/type, frequency, volume, seasonality, and/or magnitude of interactions with entities in different categories. Further, an interaction profile may include trends relating to enrollment or cancellation of enrollment of automatic interaction programs, credit worthiness, and the like. Relevant predetermined categories for pattern identification may include groceries, restaurant dining, shopping, entertainment, travel, occupational expenses, healthcare, income, utilities, mortgage/rent, taxes, services, and other relevant categories discernable from the interaction records. Demographic or background information related to the individual may include age, gender identity, marital status, dependent information, occupation, reported income, residential/work addresses, and the like. In some embodiments, the interaction profile may include information associated with the individual's interactions with other institutions, such as information to which the individual grants access (e.g., accounts and/or lines of credit).

Having created the interaction profile based on the first set of interaction records, at step 230, a more recent set of interaction records may be obtained. The more recent set of interaction records may include, for example, the most recent weeks or months of interactions (e.g., the past week, two weeks, or month), while the first set used to create the interaction profile may cover a time period of several months to multiple years (e.g., the past year or two years). However, the sets are temporally defined, in order to provide for a useful comparison, they may cover different periods of time, amounts of time, or both.

At step 240, the more recent set interactions can be compared to the interaction profile based on the first set of interactions. The comparison may be done by any suitable method, including the use of time series analysis and/or machine learning techniques/models, and the goal of the comparison can be to identify changes to/deviations from the interaction patterns identified in the first set of interaction records. An appropriate time series analysis could be used to predict future values based on those that have been previously observed, and deviations from these predictions may suggest a change in circumstance. The identified changes/deviations may include, by way of example only, increases or decreases in overall interaction frequency and/or magnitude, increases or decreases in frequency and/or magnitude in particular categories, interactions taking place in a different geographic areas, new parties with which the individual has not previously interacted, and/or no longer interacting with parties previously interacted with.

As used herein, a “machine learning model” is a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used (e.g., stochastic, gradient boosted, random seeded, recursive, epoch or batch-based). Training data sets may be used, and such sets may contain available institutional data related to users that have gone through verified changes in circumstance.

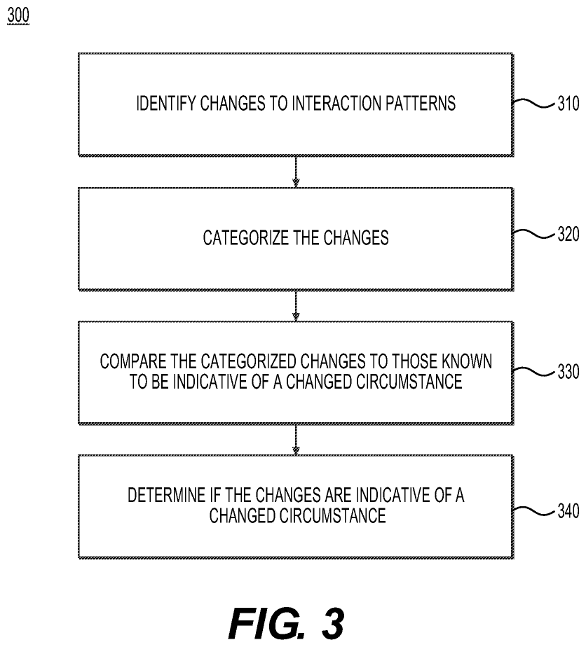

Because not all changes in interaction habits are indicative of a relevant changed circumstance, at step 250, the changes may be analyzed to determine if they may be indicative of a changed circumstance(s). This analysis can be based on a number of different criteria, including but not limited to those generated by aggregating data from other individuals, those developed by one or more experts, and those derived from the individuals own interaction records. Examples of relevant changed circumstances may include situations such as the birth or adoption of a child, a loss of employment, an illness in the family, and/or an unexpected large expense. In some embodiments, the analysis may be multiple analyses focusing on one or more particular examples of changed circumstances at a time (e.g., analyzing the changes for job loss characteristics, then analyzing the changes for an illness in the family). An exemplary method 300 of this analysis is depicted in FIG. 3.

At step 310, changes to the interaction patterns may be identified, and at step 320, those changes may be categorized. Categories may include intentional austerity-related changes (e.g., cancellation of non-essential subscriptions, reduction of expenditures for dining out, etc.), new expense-related changes (e.g., household emergency bills such as a roofer following severe weather, hiring an attorney, a large gift or loan provided to a family member, etc.), health-related changes (e.g., hospital bills, more frequent or new doctor bills, increased pharmacy spending, etc.), child-related changes (e.g., increased spending at child-related businesses such as toy stores, purchases of children's furniture, new payments to a child-care provider, etc.), or other relevant categories. Once the changes are categorized, at step 330, the categorized changes may be compared to known change patterns indicative of a particular changed circumstance.

Not all changes are necessarily indicative of a relevant change in circumstance. For example, while changes such as substituting one interaction party for another of the same type (e.g., fewer interactions with one restaurant in favor of another restaurant) may not be indicative of a changed circumstance, changes such as a reduction or cessation of regular paycheck deposits may be. By comparing the identified changes, in both frequency and magnitude, to those associated with known changed circumstances, a determination may be made, at step 340, if the changes are likely indicative of a particular changed circumstance.

Returning to FIG. 2, once the changes have been identified and analyzed, at step 260, one or more recommendations for programs may be presented to the individual. These recommendations can be based on the analysis of the changes such that, for example, an analysis that suggests the individual may have had a reduction or loss of income may generate a recommendation for a grace period, a payment deferral program, or another such modification to the schedule and/or rate for an installment loan. Other examples of analysis results and recommendations may include suggesting a 529 college savings plan for an individual who may be expecting or recently had or adopted a child, recommending a credit card offering particular rewards for an individual who has increased spending in a new category (e.g., an airline specific credit card for someone who has begun flying more often), or recommending a retirement savings account for an individual who may have recently begun a new job.

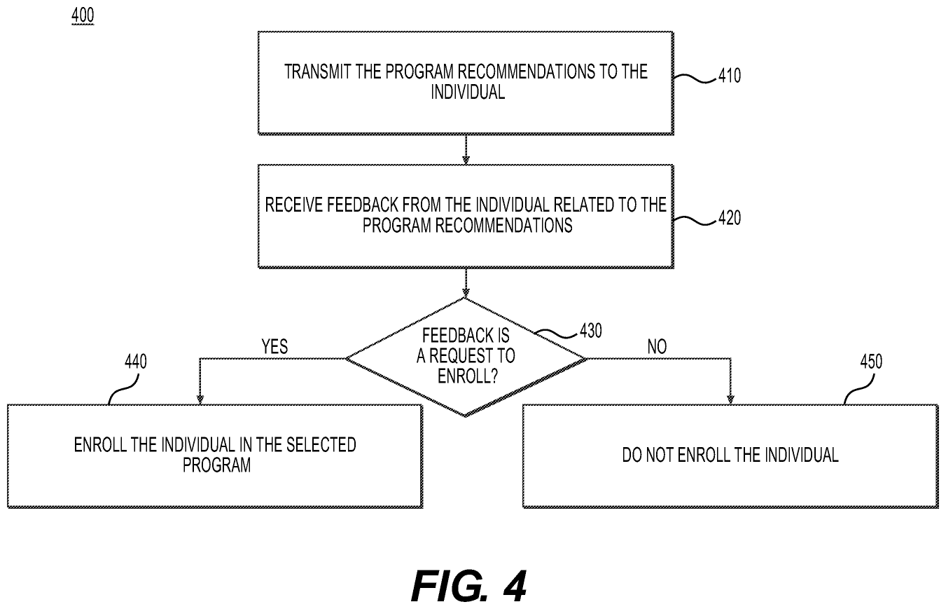

Method 400, depicted in FIG. 4, may describe a method for presenting the recommendations to an individual, and for taking appropriate action subsequently. At step 410, the recommendations can be transmitted to the individual. The recommendations may be transmitted in a number of ways, including by sending a message to a user's device using email, SMS, or other protocols, or via an institution's mobile application. Upon receipt, the individual may be prompted to provide feedback in the form of a response to the recommendations. This response may take the form of a request for enrollment and/or offer acceptance, a request for additional information, or a response that indicates the individual is not interested in the recommendation. For example, an individual may receive a recommendation to open a retirement account, such as an individual retirement account (IRA). In some embodiments, the individual would be able to provide the necessary information in the response to initiate the account opening process. In some embodiments, the response may be a request to schedule a phone call to discuss options or to receive more information via email. The individual may receive, for example and not limitation, an offer of a lower interest rate or payment deferral.

At step 420, the feedback is received, and at step 430, a determination of whether or not the feedback is a request to enroll is made. In the instance where the feedback is a request to enroll in a program or take advantage of an offer, at step 440, the individual may be enrolled in the desired program or offer (e.g., accepting the offer of a payment deferral). In the instance where the feedback is not a request to enroll in a program or take advantage of an offer, at step 450, no further action may be taken, and the individual may not be enrolled in the desired program or offer.

By monitoring interaction records as described above, relevant changes to a person's circumstances may be recognized prior to the person having adverse financial consequences. Further, having recognized a potential change to a person's life circumstances, recommendations can be generated that may be able to assist the person and avoid such outcomes as missed payments or paying extra interest, or encourage improved outcomes such as providing access to college savings plans. Accordingly, both the people and the institution involved may benefit from improved customer service and satisfaction.

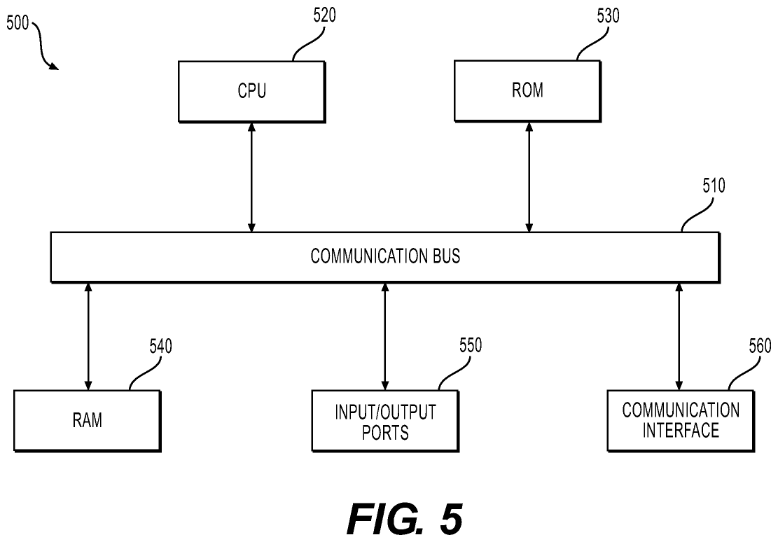

FIG. 5 depicts an example system that may execute techniques presented herein. FIG. 5 is a simplified functional block diagram of a computer that may be configured to execute techniques described herein, according to exemplary embodiments of the present disclosure. Specifically, the computer (or “platform” as it may not be a single physical computer infrastructure) may include a data communication interface 560 for packet data communication. The platform may also include a central processing unit (CPU) 520, in the form of one or more processors, for executing program instructions. The platform may include an internal communication bus 510, and the platform may also include a program storage and/or a data storage for various data files to be processed and/or communicated by the platform such as ROM 530 and RAM 540, although the system 500 may receive programming and data via network communications. The system 500 also may include input and output ports 550 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming.

All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer. Also, the presently disclosed embodiments may be applicable to any type of Internet protocol. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to, the process shown in FIGS. 2-4, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above-disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A method of determining changes in individual-specific interaction patterns indicative of changed circumstances of a respective individual, wherein the changed circumstances include one or more of a change in income, a change in expenses, or a change in monetary status for the respective individual, the method comprising:
receiving, via at least one processor from a database, a first set of interaction records relating to an individual, wherein:
each of the first set of interaction records is received from one or more of an institutional database, an automated teller machine, a point of sale terminal, or a user device, and
each of the first set of interaction records includes one or more of an identity of one or more parties involved in a financial interaction, an amount being transacted in the financial interaction, or a nature of the financial interaction;
creating, via the least one processor, an interaction profile based on the first set of interaction records, wherein the interaction profile includes information regarding individual-specific interaction patterns identified in the first set of interaction records;
monitoring, via the at least one processor, a second set of interaction records related to interactions that are more recent than those reflected in the first set of interaction records, wherein:
each of the second set of interaction records is received from one or more of an institutional database, an automated teller machine, a point of sale terminal, or a user device, and
each of the second set of interaction records includes one or more of an identity of one or more parties involved in a financial interaction, an amount being transacted in the financial interaction, or a nature of the financial interaction;
comparing, via the at least one processor, the second set of interaction records to the interaction profile to identify one or more changes to the individual-specific interaction patterns identified in the first set of interaction records;
analyzing, via the at least one processor, the one or more changes to the individual-specific interaction patterns to determine if the one or more changes is indicative of a changed circumstance for the individual;
generating, via the at least one processor, one or more recommendations for programs to be presented to the individual based on the one or more changes to the individual-specific interaction patterns identified in the first set of interaction records;
causing to display, via the at least one processor, a user interface identifying the one or more recommendations for programs to the individual;
receiving, via the at least one processor by the user interface, feedback from the individual based on the one or more recommendations for programs; and
enrolling, via the at least one processor, the individual in one or more programs based on the received feedback from the individual.

2. The method of claim 1, wherein the interaction profile includes patterns related to interaction frequency and interaction volume.

3. The method of claim 1, wherein the interaction profile includes patterns related to categories of interactions.

4. The method of claim 1, wherein the first set of interaction records includes interaction records for a period of time that is greater than one year.

5. The method of claim 1, wherein the second set of interaction records includes interaction records for a period of time that is less than two months.

6. The method of claim 1, wherein analyzing the one or more changes to the interaction patterns further comprises:
categorizing each of the one or more changes into one of a plurality of predetermined categories;
comparing the predetermined categories that the one or more changes fall under to a first set of predetermined categories known to be indicative of a first changed circumstance; and
comparing the predetermined categories that the one or more changes fall under to a second set of predetermined categories known to be indicative of a second changed circumstance.

7. The method of claim 6, wherein the first changed circumstance is a loss of employment.

8. The method of claim 7, wherein the second changed circumstance is an illness in a family of the individual.

9. (canceled)

10. The method of claim 1, wherein programs to be recommended in the one or more recommendations for programs include programs selected from a group of: grace periods, deferrals, modifications to schedules, and rate modifications.

11. A system for determining changes in individual-specific interaction patterns indicative of changed circumstances of a respective individual, wherein the changed circumstances include one or more of a change in income, a change in expenses, or a change in monetary status for the respective individual, the system comprising:
a memory storing instructions; and
a processor executing the instructions to perform a process including:
receiving, from a database, a first set of interaction records relating to an individual, wherein:
each of the first set of interaction records is received from one or more of an institutional database, an automated teller machine, a point of sale terminal, or a user device, and
each of the first set of interaction records includes one or more of an identity of one or more parties involved in a financial interaction, an amount being transacted in the financial interaction, or a nature of the financial interaction;
creating an interaction profile based on the first set of interaction records, wherein the interaction profile includes information regarding individual-specific interaction patterns identified in the first set of interaction records;
monitoring a second set of interaction records related to interactions that are more recent than those reflected in the first set of interaction records, wherein:
each of the second set of interaction records is received from one or more of an institutional database, an automated teller machine, a point of sale terminal, or a user device, and
each of the second set of interaction records includes one or more of an identity of one or more parties involved in a financial interaction, an amount being transacted in the financial interaction, or a nature of the financial interaction;
comparing the second set of interaction records to the interaction profile to identify one or more changes to the individual-specific interaction patterns identified in the first set of interaction records;
analyzing the one or more changes to the individual-specific interaction patterns to determine if the one or more changes is indicative of a changed circumstance for the individual;
generating one or more recommendations for programs to be presented to the individual based on the one or more changes to the individual-specific interaction patterns identified in the first set of interaction records;
causing to display a user interface identifying the one or more recommendations for programs to the individual;
receiving, by the user interface, feedback from the individual based on the one or more recommendations for programs; and
enrolling the individual in one or more programs based on the received feedback from the individual.

12. The system of claim 11, wherein the interaction profile includes patterns related to interaction frequency and interaction volume.

13. The system of claim 11, wherein the interaction profile includes patterns related to categories of interactions.

14. The system of claim 11, wherein the first set of interaction records includes interaction records for a period of time that is greater than one year.

15. The system of claim 11, wherein the second set of interaction records includes interaction records for a period of time that is less than two months.

16. The system of claim 11, wherein analyzing the one or more changes to the interaction patterns further comprises:
categorizing each of the one or more changes into one of a plurality of predetermined categories;
comparing the predetermined categories that the one or more changes fall under to a first set of predetermined categories known to be indicative of a first changed circumstance; and
comparing the predetermined categories that the one or more changes fall under to a second set of predetermined categories known to be indicative of a second changed circumstance.

17. The system of claim 16, wherein the first changed circumstance is a loss of employment.

18. The system of claim 17, wherein the second changed circumstance is an illness in a family of the individual.

19. (canceled)

20. A non-transitory computer-readable medium storing instructions that, when executed by a processor, cause the processor to perform a method, the method comprising:
receiving, from a database, a first set of interaction records relating to two or more accounts owned by an individual, wherein:
each of the first set of interaction records is received from one or more of an institutional database, an automated teller machine, a point of sale terminal, or a user device, and
each of the first set of interaction records includes one or more of an identity of one or more parties involved in a financial interaction, an amount being transacted in the financial interaction, or a nature of the financial interaction;
creating an interaction profile based on the first set of interaction records, wherein the interaction profile includes information regarding individual-specific interaction patterns, the individual-specific interaction patterns including an interaction frequency, an interaction volume, and categories of interactions;
monitoring a second set of interaction records related to interactions that are more recent than those reflected in the first set of interaction records, wherein:
each of the second set of interaction records is received from one or more of an institutional database, an automated teller machine, a point of sale terminal, or a user device, and
each of the second set of interaction records includes one or more of an identity of one or more parties involved in a financial interaction, an amount being transacted in the financial interaction, or a nature of the financial interaction;
comparing the second set of interaction records to the interaction profile to identify one or more changes to the interaction frequency, the interaction volume, or the categories of interactions identified in the first set of interaction records;
analyzing the one or more changes to the interaction frequency, the interaction volume, or the categories of interactions to determine if the one or more changes is indicative of a changed circumstance for the individual, wherein the changed circumstances include one or more of a change in income, a change in expenses, or a change in monetary status for the respective individual;
generating one or more recommendations for programs to be presented to the individual based on the one or more changes to the user-specific interaction patterns identified in the first set of interaction records;
causing to display a user interface identifying the one or more recommendations for programs to the individual;
receiving, by the user interface, feedback from the individual based on the one or more recommendations for programs; and
enrolling the individual in one or more programs included in the one or more recommendations for programs in response to the received feedback from the individual.

21. The method of claim 1, wherein the comparing the second set of interaction records to the interaction profile further comprises:
determining, via a trained machine learning model, changes in the interaction patterns identified in the interaction profile compared to the second set of interaction records, wherein the trained machine learning model is trained, based on a plurality of interaction patterns specific to the individual, to determine changes in interaction patterns specific to the individual.

22. The system of claim 11, wherein the comparing the second set of interaction records to the interaction profile further comprises:
determining, via a trained machine learning model, changes in the interaction patterns identified in the interaction profile compared to the second set of interaction records, wherein the trained machine learning model is trained, based on a plurality of interaction patterns specific to the individual, to determine changes in interaction patterns specific to the individual.
